(19) United States
(12) Patent Application Publication
(10) Pub. No.: US 2020/0058957 A1
(43) Pub. Date: Feb. 20, 2020

(54) LITHIUM-AIR BATTERY AND METHOD OF MANUFACTURING THE SAME

(71) Applicants: Hyundai Motor Company, Seoul (KR); Kia Motors Corporation, Seoul (KR)

(72) Inventors: Eun Ji Kwon, Hwaseong (KR); Yoon Ji Lee, Bucheon (KR)

(21) Appl. No.: 16/197,967

(22) Filed: Nov. 21, 2018

(30) Foreign Application Priority Data
Aug. 20, 2018 (KR) 10-2018-0096616

(51) Int. Cl. H01M 10/0565; H01M 10/0525; H01M 12/08

(52) U.S. Cl. CPC H01M 10/0565; H01M 2220/20; H01M 12/08; H01M 10/0525

(57) ABSTRACT

Disclosed are a lithium-air battery and a method of manufacturing the same. The weight of the battery may be reduced and the energy density thereof may be improved by eliminating two separators, which are stacked on a gas diffusion layer and a current collector in the related art, and by using two kinds of gel polymer electrolyte membranes, each including a gelled polymer matrix impregnated with an electrolyte, as a separation membrane. The volatilization, leakage or bias of the electrolyte may be prevented by restricting the fluidity of the electrolyte. In addition, the capacity and lifespan of the battery may be increased.

### CROSS-REFERENCE TO RELATED APPLICATION

This application claims under 35 U.S.C. § 119(a) the benefit of priority to Korean Patent Application No. 10-2018-0096616 filed on Aug. 20, 2018, the entire contents of which are incorporated herein by reference.

### TECHNICAL FIELD

The present invention relates to a lithium-air battery and a method of manufacturing the same. The lithium-air battery may be manufactured to reduce the weight thereof, improve the energy density thereof and increase the capacity and lifespan thereof by eliminating two bipolar plate, which are stacked on a gas diffusion layer and a current collector in a conventional lithium-air battery. In addition, the lithium-air battery may include two kinds of gel polymer electrolyte membranes, each including a gelled polymer matrix impregnated with an electrolyte, as a separation membrane.

### BACKGROUND

Components, such as a fixture or a bipolar plate, which are not related to energy storage and conversion of a battery, may cause reduction in energy density when designing a large-capacity battery for a lithium-air battery system. For example, when a stacking system is implemented, a bipolar plate and other components occupy volumes and weights that are four times the volume and the weight of a cathode/separator/anode assembly of a battery, leading to difficulty in realizing high energy density of a lithium-air battery. Accordingly, studies have been conducted to reduce the weights of components and improve the energy density of a lithium-air battery.

In the related art, a fuel cell stack has a structure in which bipolar plates are disposed on both sides of a membrane electrode assembly including a fuel electrode, an electrolyte membrane and an air electrode. In the fuel cell having this structure, the bipolar plates may be located at both distal ends, and may thus isolate a liquid electrolyte within a unit cell. However, when manufacturing a stacked-type battery in which lithium-air unit cells are stacked by adopting the above structure, two bipolar plates may be provided in each unit cell, thus making it difficult to reduce the weight of the battery and to improve the energy density of the battery. Although a lithium-air battery of the related art has excellent theoretical energy density, in the process of realizing a battery system, the energy density thereof may be greatly reduced and the weight thereof may be increased due to the installation of components for realizing performance. Accordingly, there is the need to develop a technology for improving the energy density of a battery system and minimizing the weight thereof.

The above information disclosed in this Background section is only for enhancement of understanding of the background of the invention and therefore it may contain information that does not form the prior art that is already known in this country to a person of ordinary skill in the art.

### SUMMARY OF THE INVENTION

In preferred aspects, provided are a lithium-air battery and a method of manufacturing the same. The lithium-air battery may have reduced weight and improved energy density by eliminating bipolar plates. For instance, the lithium-air battery may include gel polymer electrolyte membranes, each of which may include a gel polymer matrix impregnated with an electrolyte as being used as a separation membrane. The term “gel polymer” or “polymer gel” as referred to herein includes solid polymers and liquid components (e.g., solvent components, or electrolytes) that may provide properties of the solid polymer (e.g., mechanical properties such as hardness) at the same time that maintains properties provided by the liquid components. In certain embodiment, the gel polymer may suitably include solid polymers impregnated with one or more liquid electrolytes such that the gel polymer may maintain mechanical properties (e.g., hardness or shape) of the solid polymer and retain ionic conductivity or ionic properties from the liquid electrolyte.

In addition, the method of manufacturing a lithium-air battery may provide improved electrode stability and increased battery capacity and lifespan by forming two kinds of gel polymer electrolyte membranes, each of which may include an electrolyte suitable for a corresponding one of a cathode and an anode.

However, the present invention may not be limited to the above-mentioned aspects. Various embodiments of the invention will be more apparent from the following description, and will be realized by means of the elements and combinations thereof pointed out in the appended claims.

In one aspect, provided is a lithium-air battery including a cathode, a gel polymer electrolyte membrane, and an anode and the gel polymer electrolyte membrane is disposed between the cathode and the anode.

The gel polymer electrolyte membrane may include a first gel polymer electrolyte membrane and a second gel polymer electrolyte membrane. Preferably, the first gel polymer electrolyte membrane may contact with the cathode and the second gel polymer electrolyte membrane may contact with the anode.

The first gel polymer electrolyte membrane may suitably include a first polymer matrix and a first electrolyte impregnated in the first polymer matrix, and the second gel polymer electrolyte membrane may include a second polymer matrix and a second electrolyte impregnated in the polymer matrix. The first polymer matrix and the second polymer matrix may be same or different. The first electrolyte and the second electrolyte may be same or different. When different, the first polymer matrix can be different in one or more ways. For instance, the first polymer matrix and the second polymer matrix can differ in molecular weight (e.g., weight average), by about, for example, 5, 10, 15, 20, 30, 40, 50, 60, 70, 80, 90 or 100 percent or more. In addition, the first polymer matrix and the second polymer matrix can differ in polymer type, for example, the first polymer matrix may be an acryl-containing resins and the second polymer matrix may not contain polymerized acrylate unites.

The first polymer matrix and/or the second polymer matrix may have a semi-interpenetrating polymer network structure in which polymer chains are crosslinked with each other.

The term “semi-interpenetrating polymer network structure (SIPN)” as used herein refers to a polymer or polymers formed by one or more networks (e.g., entangled, interlacing or crosslinked polymer) which may be formed one or more linear or branched polymer blends constituting the structure. The SIPN may suitably include microstructures formed in the spaces in the networks (e.g., between the interlacing polymers) such as cavities, pores, channels, or labyrinth or the like, which may accommodate or be filled with other materials. The SIPN may be constituted the one or more networks which are not completely crosslinked, such that these networking polymers may be broken without breaking chemical bonds (e.g., covalent bonds). For example, the SIPN may include less than about 10%, 20%, 30%, 40%, 50%, 60%, 70%, 80%, or 90% of free-polymers, which are not involved in the network structure by crosslinking.

The first polymer matrix and/or the second polymer matrix may suitably include one or more polymers selected from the group consisting of polymethylmethacrylate, polyacrylonitrile, polyethylene oxide, polymethylmethacrylate-co-polystyrene, polyvinylidene fluoride, and polytetrafluoroethylene.

The first electrolyte may suitably include one or more organic solvents selected from the group consisting of an amide-based compound, a nitrile-based compound and a sulfur-based compound. A mixing ratio of the first polymer matrix to the first electrolyte may suitably range from about 10:90 to about 40:60 by weight.

The second electrolyte may suitably include one or more organic solvents selected from the group consisting of an ether-based compound, a carbonate-based compound, and an ionic liquid.

A mixing ratio of the second polymer matrix to the second electrolyte may suitably range from about 30:70 to about 40:60 by weight.

The first gel polymer electrolyte membrane may suitably have a thickness is greater than a thickness of the second gel polymer electrolyte membrane.

The lithium-air battery may further include a separation membrane disposed between the first gel polymer electrolyte membrane and the second gel polymer electrolyte membrane. Preferably, the separation membrane may include a lithium-ion conductive separation membrane or a polymer separation membrane.

In another aspect, provided is a method of manufacturing a lithium-air battery. The method may include preparing a first gel polymer electrolyte membrane by coating a first gel polymer electrolyte slurry on a first surface of a cathode, preparing a second gel polymer electrolyte membrane by coating a second gel polymer electrolyte slurry on a first surface of an anode, and bonding the first gel polymer electrolyte membrane onto the second gel polymer electrolyte membrane. The first gel polymer electrolyte membrane may include a first polymer matrix and a first electrolyte impregnated in the first polymer matrix, and the second gel polymer electrolyte membrane may include a second polymer matrix and a second electrolyte impregnated in the second polymer matrix.

The first surface of the cathode and the first surface of the anode may face each other such that the first surface of the cathode and the first surface of the anode may be indirectly bonded or attached via the first polymer electrolyte membrane and the second polymer electrolyte membrane. As such the first surface of the cathode and the first surface of the anode face each other after the bonding the first gel polymer electrolyte membrane onto the second gel polymer electrolyte membrane.

The first gel polymer electrolyte slurry may suitably include an amount of about 13 to 28% by weight of a first polymer, an amount of about 62 to 84% by weight of the first electrolyte, an amount of about 1 to 3% by weight of a first initiator, and an amount of about 2 to 7% by weight of a first crosslinking agent based on the total weight of the first gel polymer electrolyte slurry.

The term “initiator” as used herein refers to a compound or substance that promotes or starts a chain reaction (e.g., polymerization).

The term “crosslinking agent” as used herein refers to a compound or reagent for polymerization, for example, by forming a chemical bond between monomeric units of the polymer or a polymer chains. In another preferred embodiment, the preparing the first gel polymer electrolyte membrane may include polymerizing (e.g., gelling) the first gel polymer electrolyte slurry coated on the first surface of the cathode at a temperature of about 60 to 80° C. for about 6 to 12 hours to form the first gel polymer electrolyte membrane.

The term “gelling” as used herein refers to a process of solidifying a liquid or fluid material to a gel state, i.e. phase of semi-solid or soft solid. The gel refers a material that may maintain a shape or volume temporarily and be movable, fragile, flexible or changeable upon stress or pressure applied thereon. In certain embodiments, the gelling may include polymerizing of the liquid resin to a soft polymer or gel.

The method may further include additionally impregnating the first electrolyte into the first polymer matrix of the first gel polymer electrolyte membrane after the preparing the first gel polymer electrolyte membrane.

The second gel polymer electrolyte slurry may suitably include an amount of about 22 to 38% by weight of a second polymer, an amount of about 54 to 76% by weight of the second electrolyte, an amount of about 1 to 3% by weight of a second initiator, and an amount of about 1 to 5% by weight of a second crosslinking agent based on the total weight of the first gel polymer electrolyte slurry.

The first polymer and the second polymer may be same or different. The first electrolyte and the second electrolyte may be same or different. The first initiator and the second initiator may be same or different. The first crosslinking agent and the second crosslinking agent may be same or different. The first gel polymer electrolyte slurry and the second gel polymer electrolyte slurry may be same or different.

The preparing the second gel polymer electrolyte membrane may include polymerizing (e.g., gelling) the second gel polymer electrolyte slurry coated on the one surface of the anode at a temperature of about 60 to 80° C. for about 6 to 12 hours to form the second gel polymer electrolyte membrane.

The method may further include additionally impregnating the second electrolyte into the second polymer matrix of the second gel polymer electrolyte membrane after the preparing the second gel polymer electrolyte membrane.

The method may further include bonding a separation membrane onto the second gel polymer electrolyte membrane after the preparing the second gel polymer electrolyte membrane and before the bonding the first gel polymer electrolyte membrane onto the second gel polymer electrolyte membrane.

Further provided is a lithium-air battery as described herein.

Other aspects of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a perspective view of a conventional lithium-air battery;

FIG. 2 is a cross-sectional view of a conventional stacked-type lithium-air battery;

FIG. 3 is a perspective view of an exemplary lithium-air battery in Embodiment 1 according to an exemplary embodiment of the present invention;

FIG. 4 is a perspective view of an exemplary lithium-air battery having an exemplary bi-cell structure according to an exemplary embodiment of the present invention;

FIG. 5 is a cross-sectional view of an exemplary stacked-type lithium-air battery according to an exemplary embodiment of the present invention;

FIG. 6 is an exemplary manufacturing process of an exemplary lithium-air battery according to an exemplary embodiment of the present invention;

FIG. 7 is a charge/discharge graph of a lithium-air battery of Comparative Example 1; and

FIG. 8 is a charge/discharge graph of an exemplary lithium-air battery of Embodiment 1 according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes, will be determined in part by the particular intended application and use environment.

In the figures, reference numbers refer to the same or equivalent parts of the present invention throughout the several figures of the drawing.

### DETAILED DESCRIPTION

The above and other objects, features and advantages of the invention will become apparent with reference to embodiments described below in detail in conjunction with the accompanying drawings. The invention, however, is not limited to the embodiments disclosed hereinafter, and may be embodied in many different forms. Rather, these exemplary embodiments are provided so that the present invention will be thorough and complete and will fully convey the scope of the invention to those skilled in the art.

In the drawings, the same or similar elements are denoted by the same reference numerals, and the dimensions of constituent elements are exaggerated for clarity. It will be understood that, although the terms “first,” “second,” etc. may be used herein to describe various elements, these elements should not be limited by these terms. These terms are only used to distinguish one element from another element. Thus, a first element may be termed a second element, and similarly, a second element may be termed a first element without departing from the scope of the invention. The expression of singularity includes a plural meaning unless the singular expression is explicitly different in context.

In the specification, the terms “comprising,” “including,” and “having” shall be understood to designate the presence of particular features, numbers, steps, operations, elements, parts, or combinations thereof but not to preclude the presence or addition of one or more other features, numbers, steps, operations, elements, parts, or combinations thereof. Further, it will be understood that, when an element such as a layer, film, region or substrate is referred to as being “on” or “under” another element, it can be “directly” on or under the other element or can be “indirectly” formed such that an intervening element is also present.

Unless otherwise indicated, all numbers, values and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

For example, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Further, where a numerical range is disclosed herein, such range is continuous, and includes unless otherwise indicated, every value from the minimum value to and including the maximum value of such range. Still further, where such a range refers to integers, unless otherwise indicated, every integer from the minimum value to and including the maximum value is included.

In the context of this specification, where a range is stated for a parameter, it will be understood that the parameter includes all values within the stated range, inclusive of the stated endpoints of the range. For example, a range of “5 to 10” will be understood to include the values 5, 6, 7, 8, 9, and 10 as well as any sub-range within the stated range, such as to include the sub-range of 6 to 10, 7 to 10, 6 to 9, 7 to 9, etc., and inclusive of any value and range between the integers which is reasonable in the context of the range stated, such as 5.5, 6.5, 7.5, 5.5 to 8.5 and 6.5 to 9, etc. For example, a range of “10% to 30%” will be understood to include the values 10%, 11%, 12%, 13%, and all integers up to and including 30%, as well as any sub-range within the stated range, such as to include the sub-range of 10% to 15%, 12% to 18%, 20% to 30%, etc., and inclusive of any value and range between the integers which is reasonable in the context of the range stated, such as 10.5%, 15.5%, 25.5%, etc.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In general, a lithium-air battery, unlike other lithium-ion battery systems, has an open system that requires air flow because oxygen is used as an active material. In other words, a lithium-air battery can generate energy by causing two kinds of oxygen (gas) and electrolyte (liquid), having different physical phases, to electrochemically react at a cathode (solid). However, when such battery has an air flow, battery overvoltage may be greatly increased due to volatilization of the electrolyte as charging and discharging are continued, thereby deteriorating the performance of the battery.

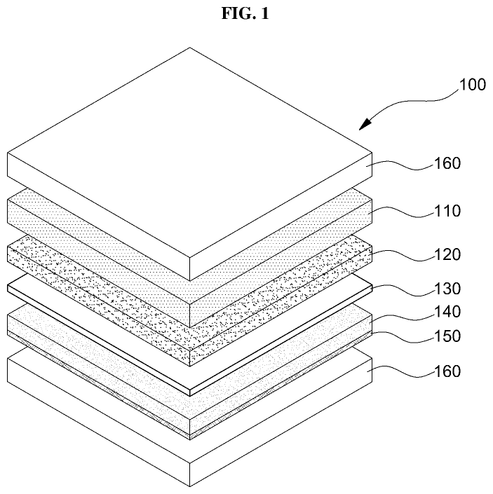

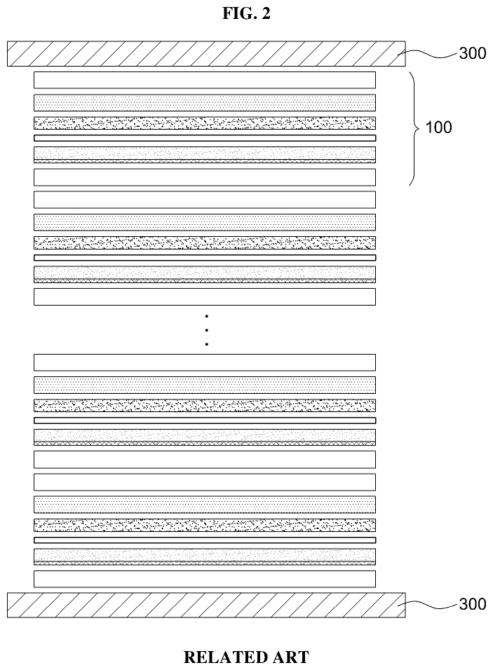

In addition, the conventional lithium-air battery includes bipolar plates, so the weight of the battery may be increased. FIG. 1 is a perspective view of a conventional lithium-air battery 100. FIG. 2 is a cross-sectional view of a conventional stacked-type lithium-air battery. As shown in FIGS. 1 and 2, the conventional lithium-air battery 100 is implemented by an assembly of gas diffusion layer 110/cathode 120/separation membrane 130/anode 140/current collector 150. Bipolar plates 160 are stacked on one surface of the gas diffusion layer 110 and on one surface of the current collector 150. For example, in stacked-type lithium-air battery shown in FIG. 2, two bipolar plates 160 are provided in each lithium-air unit cell 100, whereby the weight of the battery is increased, and thus there is a limit to the improvement of energy density.

In order to solve the problem of battery overvoltage due to electrolyte volatilization and the problem of decrease in energy density due to the heavy weight of the battery, the present invention provides a battery in which bipolar plates stacked on a gas diffusion layer and a current collector are eliminated and in which a gel polymer electrolyte membrane including a gelled polymer matrix impregnated with an electrolyte is used.

Particularly, a polymer matrix may be formed to have a network structure by polymerizing into a gel state, or being gelled, through interaction between polymer chains by physical crosslinking. As such, a gel polymer electrolyte membrane may be formed by impregnating the polymer matrix with an electrolyte, thereby minimizing the volatilization or leakage of the electrolyte through an air flow path. In addition, two kinds of gel polymer electrolyte membranes may be used on each electrode, i.e. cathode and anode such that the each electrode may include an electrolyte suitable for its function. As consequence, the energy density may be greatly improved, and a separate separator may not be provided, thereby reducing the weight of the battery. For example, when stacking 100 cells, a volume energy density may be improved about eight times, and a weight energy density can be improved about five times.

Hereinafter, the above-described lithium-air battery and a manufacturing method thereof according to the present invention will be described in more detail with reference to the drawings.

The present invention provides a lithium-air battery 200 and a method of manufacturing the same. The lithium-air battery 200 may include a first gel polymer electrolyte membrane 231 that is in contact with a cathode 220 and a second gel polymer electrolyte membrane 232 that is in contact with an anode 240. Preferably, the lithium-air battery 200 of the present invention may be configured such that a cathode 220, a gel polymer electrolyte membrane and an anode 240 are stacked in that order, such that the gel polymer electrolyte membrane may include a first gel polymer electrolyte membrane 231 that is in contact with the cathode 220 and a second gel polymer electrolyte membrane 232 that is in contact with the anode 240. The first gel polymer electrolyte membrane 231 may include a first polymer matrix and a first electrolyte impregnated in the polymer matrix, and the second gel polymer electrolyte membrane 232 may include a second polymer matrix and a second electrolyte impregnated in the polymer matrix. The first polymer matrix and the second polymer matrix may be same or different. The first electrolyte and the second electrolyte may be same or different. Preferably, the first polymer matrix may be different from the second polymer matrix, and the first electrolyte may be different from the second electrolyte.

The polymer matrix, which is included in each of the first gel polymer electrolyte membrane 231 and the second gel polymer electrolyte membrane 232, may have a semi-interpenetrating polymer network structure in which polymer chains interact and are crosslinked with each other by physical crosslinking. The gelled polymer matrix having this structure may provide excellent electrolyte retention ability while preventing dissolution attributable to the electrolyte. In addition, fluidity of the electrolyte and delocalization or bias of the electrolyte attributable to gravity or external impacts may be prevented. In addition, the interface between the electrode and the electrolyte may be stabilized, and an air flow path may be ensured by maintaining pores in a porous carbon electrode that uses external air as a power source.

The polymer matrix may suitably include one or more polymers selected from the group consisting of polymethylmethacrylate (PMMA), polyacrylonitrile, polyethylene oxide, polymethylmethacrylate-co-polystyrene (PMMA-PS), polyvinylidene fluoride, and polytetrafluoroethylene.

The gel polymer electrolyte membrane may suitably include two kinds of gel polymer electrolyte membranes, i.e. a first gel polymer electrolyte membrane for the cathode 220 and a second gel polymer electrolyte membrane for the anode 240, respectively. For example, an electrolyte for lithium-air batteries may be required to have excellent high-voltage stability, excellent stability at the interface between an electrode and the electrolyte, and excellent reactivity for realizing capacity, which has a trade-off relationship with stability. Accordingly, for obtaining stability of the cathode 220 and the anode 240, an electrolyte (first electrolyte)containing an organic solvent favorable for lithium protection may be included in the second gel polymer electrolyte membrane 232, which is in contact with the anode 240, and an electrolyte (second electrolyte) containing a highly reactive organic solvent favorable for realizing the capacity of the cathode may be included in the first gel polymer electrolyte membrane 231, which is in contact with the cathode 220, thereby improving the capacity and lifespan of the battery while stabilizing the electrodes.

Particularly, the first gel polymer electrolyte membrane 231 may include a first polymer matrix and a first electrolyte impregnated in the polymer matrix. The first electrolyte may suitably include a lithium salt dissolved in an organic solvent at a concentration of about 0.1 to 5 M. In particular, an organic solvent having a high capacity at the cathode 220 may preferably be used for the first electrolyte. The organic solvent may suitably have a viscosity of about 1 to 50 cP at a temperature of about 25° C. and a high donor number, and may be stable to oxygen radicals and highly reactive. However, when this organic solvent used in the first electrolyte is used for the anode 240, there is a risk of deterioration due to high reactivity. Preferably, the organic solvent may suitably include one or more selected from the group consisting of an amide-based compound, a nitrile-based compound and a sulfur-based compound. The amide-based compound may suitably include one or more selected from the group consisting of N-methylformamide (NMF), dimethylacetamide (DMAc), N-methyl-2-pyrrolidone (NMP), and diethylacetamide (DEA). The nitrile-based compound may suitably include acetonitrile. The nitrile-based compound may be acetonitrile. The sulfur-based compound may suitably include one or more selected from the group consisting of dimethylsulfoxide (DMSO), and sulfolane.

The first gel polymer electrolyte membrane 231 may be formed such that the mixing ratio of the polymer matrix to the first electrolyte ranges from about 10:90 to 40:60 by weight. At this time, when the mixing ratio of the polymer matrix to the first electrolyte is less than about 10:90 by weight, the amount of the first electrolyte may be greater than that of the polymer matrix, which makes it difficult to form a gel polymer electrolyte membrane. On the other hand, when the mixing ratio of the polymer matrix to the first electrolyte is greater than about 40:60 by weight, a crosslinking side reactive polymer may be present, which may deteriorate the performance of the battery. Preferably, the mixing ratio of the polymer matrix to the first electrolyte may range from about 10:90 to about 25:75 by weight.

The second gel polymer electrolyte membrane 232 may include a second polymer matrix and a second electrolyte impregnated in the polymer matrix. The second electrolyte may suitably include a lithium salt dissolved in an organic solvent at a concentration of about 0.1 to 5 M. In particular, an organic solvent favorable for lithium protection may preferably be used for the second electrolyte. Preferably, the organic solvent may suitably include one or more selected from the group consisting of an ether-based compound, a carbonate-based compound, and an ionic liquid. The ether-based compound may suitably include one or more selected from the group consisting of tetraethylene glycol dimethyl ether (TEGDME), diethylene glycol diethyl ether (DEGDEE), and dimethyl ether (DME). The carbonate-based compound may suitably include one or more selected from the group consisting of ethyl carbonate (EC), ethyl methyl carbonate (EMC), and diethyl carbonate (DEC). The ionic liquid may suitably include one or more selected from the group consisting of glyme, imidazolium, and pyridinium.

The second gel polymer electrolyte membrane 232 may be formed such that the mixing ratio of the polymer matrix to the second electrolyte may range from about 30:70 to about 40:60 by weight. When the mixing ratio of the polymer matrix to the second electrolyte is less than about 30:70 by weight, the amount of the second electrolyte may be much greater than that of the polymer matrix, which may prevent formation of a gel polymer electrolyte membrane. When the mixing ratio of the polymer matrix to the second electrolyte is greater than about 40:60 by weight, a crosslinking side reactive polymer may be present, and the amount of the polymer matrix may be excessively large, which may deteriorate the lithium-ion conductivity. Preferably, the mixing ratio of the polymer matrix to the second electrolyte may range from about 30:70 to about 35:65 by weight.

A thickness of the first gel polymer electrolyte membrane 231 may be greater than a thickness of the second gel polymer electrolyte membrane 232. When the first gel polymer electrolyte membrane 231 is thicker than the second gel polymer electrolyte membrane 232, the ability of the cathode to realize capacity may be increased such that the lifespan of the battery may be prolonged. The first gel polymer electrolyte membrane 231 may suitably have a thickness of about 60 to 80 μm. The second gel polymer electrolyte membrane 232 may suitably have a thickness of about 45 to 55 μm. When the thickness of the first gel polymer electrolyte membrane 231 and the thickness of the second gel polymer electrolyte membrane 232 do not satisfy the respective ranges, the energy density may decrease and the battery resistance may increase.

The lithium-air battery 200 may further include a separation membrane 233, which may be disposed between the first gel polymer electrolyte membrane 231 and the second gel polymer electrolyte membrane 232. The separation membrane 233 may physically prevent the two kinds of gel polymer electrolyte membranes from being mixed with each other after the charge and discharge cycle. The separation membrane 233 may suitably include a lithium-ion conductive separation membrane or a polymer separation membrane. The lithium-ion conductive separation membrane may suitably include PEO₁₅LiTFSI.

The lithium-air battery 200 may further include a gas diffusion layer 210, which is stacked on the other surface of the cathode 220, and a current collector 250, which is stacked on the other surface of the anode 240. The gas diffusion layer 210 may be a metal foam or a carbon sheet. The current collector 250 may include one or more selected from the group consisting of nickel, copper, and stainless steel (SUS).

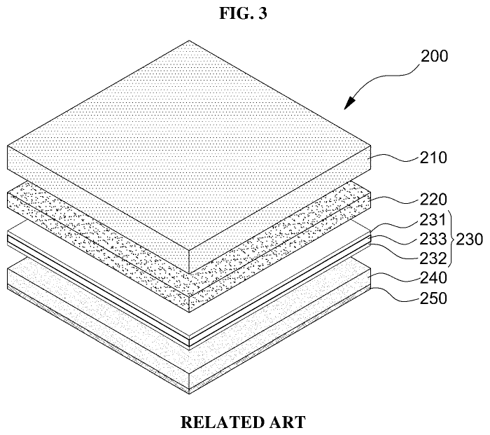

FIG. 3 is a perspective view of an exemplary lithium-air battery 200 in Embodiment 1 according to an exemplary embodiment of the present invention. The lithium-air battery 200 shown in FIG. 3 has a unit cell structure including a gas diffusion layer 210, a cathode 220, a separation membrane 230, an anode 240, and a current collector 250. The separation membrane 230 has a structure including a first gel polymer electrolyte membrane 231, a lithium-ion conductive separation membrane 233, and a second gel polymer electrolyte membrane 232.

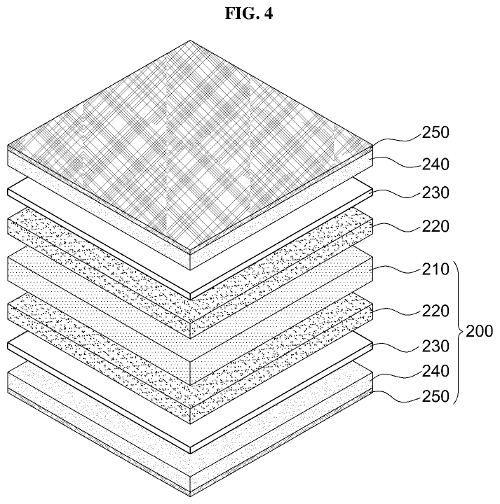

FIG. 4 is a perspective view of an exemplary lithium-air battery having an exemplary bi-cell structure according to an exemplary embodiment of the present invention. The lithium-air battery shown in FIG. 4 has a bi-cell structure in which each lithium-air battery 200 shown in FIG. 3 may be one unit cell and shares the gas diffusion layer 210 with the other. For example, the lithium-air battery may be configured such that a cathode 220, a separation membrane 230, an anode 240 and a current collector 250 are stacked in that order on each of two opposite sides of the gas diffusion layer 210. Alternatively, the gel polymer electrolyte membrane may be disposed between the cathode and the anode.

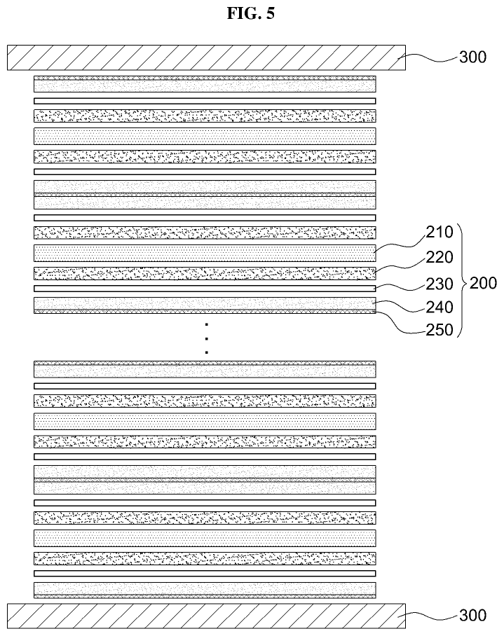

FIG. 5 is a cross-sectional view of a stacked-type lithium-air battery according to an exemplary embodiment of the present invention. The stacked-type lithium-air battery shown in FIG. 5 is configured such that a plurality of bi-cells, each having the structure shown in FIG. 4, may be stacked. The stacked-type lithium-air battery having this structure may greatly improve the volume energy density and the weight energy density by eliminating two separators, which are provided in each unit cell in the related art, and by stacking the bi-cells in parallel. In addition, the elimination of separators may promote the design of a battery in which a flow path is sufficiently secured. In addition, as a result of forming two kinds of gel polymer electrolyte membranes for the separation membrane 230, processability of the electrodes may be secured, for example, deteriorating the strength due to the high specific surface area of the electrolyte may be prevented.

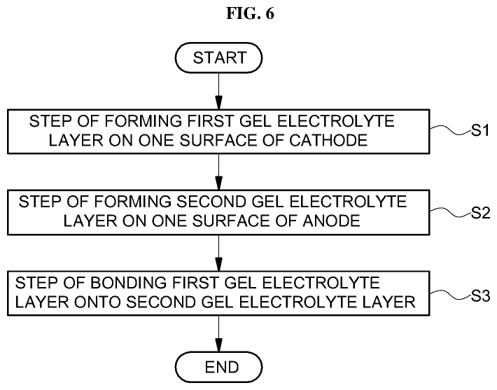

FIG. 6 is a manufacturing process diagram of an exemplary lithium-air battery 200 according to an exemplary embodiment of the present invention. As shown in FIG. 6, the method of manufacturing the lithium-air battery 200 may include a step of forming a first gel polymer electrolyte membrane 231 on one surface of a cathode 220 (S1), a step of forming a second gel polymer electrolyte membrane 232 on one surface of an anode 240 (S2), and a step of bonding the first gel polymer electrolyte membrane 231 onto the second gel polymer electrolyte membrane 232 (S3).

The method of manufacturing the lithium-air battery 200 may include a step of preparing a first gel polymer electrolyte membrane 231 by coating a first gel polymer electrolyte slurry on one surface (e.g. first surface) of a cathode 220, a step of preparing a second gel polymer electrolyte membrane 232 by coating a second gel polymer electrolyte slurry on one surface (e.g., first surface) of an anode 240, and a step of bonding the first gel polymer electrolyte membrane 231 onto the second gel polymer electrolyte membrane 232. The first gel polymer electrolyte membrane 231 may include a first polymer matrix and a first electrolyte impregnated in the polymer matrix, and the second gel polymer electrolyte membrane 232 may include a second polymer matrix and a second electrolyte impregnated in the polymer matrix. The first surface of the cathode and the first surface of the anode may face each other, and may be attached, or connected indirectly via the gel polymer electrolyte membrane including the first gel polymer electrolyte membrane and the second gel polymer electrolyte membrane.

The first gel polymer electrolyte slurry may include an amount of about 13 to 28% by weight of a first polymer, an amount of about 62 to 84% by weight of a first electrolyte, an amount of about 1 to 3% by weight of an initiator, and an amount of about 2 to 7% by weight of a crosslinking agent based on the total weight of the first gel polymer electrolyte slurry. When the content of the first electrolyte is less than about 62% by weight, the lithium-ion conductivity may be decreased. When the content of the first electrolyte is greater than about 84% by weight, the first electrolyte may be excessively impregnated in the polymer matrix and may leak therefrom. The initiator may be used to initiate polymerization of the polymer to be gelled. The initiator may suitably include one or more selected from the group consisting of 2,2′-azo-bisisobutyronitrile (AIBN) and benzoyl peroxide (BPO).

The step of preparing the first gel polymer electrolyte membrane 231 may include a step of coating a slurry on the cathode 220, for example, using a blade-casting method and a step of gelling the same. Likewise, the step of preparing the second gel polymer electrolyte membrane 232 may include a step of coating a slurry on the anode 240, for example, using a blade-casting method and a step of gelling the same.

Particularly, in the step of preparing the first gel polymer electrolyte membrane 231, the first gel polymer electrolyte membrane 231 may be formed by gelling the first gel polymer electrolyte slurry, coated on the first surface of the cathode 220, at a temperature of about 60 to 80° C. for about 6 to 12 hours. When the first gel polymer electrolyte slurry is coated on the first surface of the cathode 220 and heat may be then applied thereto, crystallization may be caused by interaction between the polymer chains in the slurry. This partial crystallization may work as physical crosslinking, thereby forming a polymer matrix having a network structure. The polymer matrix formed in this manner may be impregnated with the first electrolyte, with the result that the gel polymer electrolyte membrane may be formed. When the gelling temperature is less than about 60° C., the first gel polymer electrolyte slurry may not be gelled properly, and unreacted polymer may be present in the first electrolyte, which may lead to electrolyte deterioration. When the gelling temperature is greater than about 80° C., the first electrolyte itself may deteriorate, and battery performance may be deteriorated.

The manufacturing method may further include a step of additionally impregnating the first electrolyte into the first polymer matrix of the first gel polymer electrolyte membrane 231 after the step of preparing the first gel polymer electrolyte membrane 231. The additional injection of the first electrolyte may be performed in order to compensate for the amount of the first electrolyte that may be lost during the process of synthesizing the gel polymer electrolyte membrane. Since the first electrolyte is present in the state of being impregnated in the polymer matrix having a network structure, leakage or delocalization of the electrolyte may be prevented.

The second gel polymer electrolyte slurry may include an amount of about 22 to 38% by weight of a second polymer, an amount of about 54 to 76% by weight of a second electrolyte, an amount of about 1 to 3% by weight of an initiator, and an amount of about 1 to 5% by weight of a crosslinking agent based on the total weight of the second gel polymer electrolyte slurry. In the step of preparing the second gel polymer electrolyte membrane 232, the second gel polymer electrolyte membrane 232 may be formed by gelling the second gel polymer electrolyte slurry, coated on the first surface of the anode 240, at a temperature of about 60 to 80° C. for about 6 to 12 hours.

The manufacturing method may further include a step of additionally impregnating the second electrolyte into the second polymer matrix of the second gel polymer electrolyte membrane 232 after the step of preparing the second gel polymer electrolyte membrane 232. For the same reason as described above, the additional injection of the second electrolyte may be performed in order to compensate for the amount of the second electrolyte that may be lost during the process of synthesizing the gel polymer electrolyte membrane.

The manufacturing method may further include a step of bonding a separation membrane 233 onto the second gel polymer electrolyte membrane 232 after the step of preparing the second gel polymer electrolyte membrane 232 and before the step of bonding the first gel polymer electrolyte membrane 231 onto the second gel polymer electrolyte membrane 232. The bonding of the separation membrane 233 may be performed in order to prevent crossing over of free solvents and ions of the first gel polymer electrolyte membrane 231 and the second gel polymer electrolyte membrane 232.

The manufacturing method may further include a step of bonding a gas diffusion layer 210 to the other surface (second surface) of the cathode 220. The gas diffusion layer 210 may be formed on the cathode 220 to serve as a passage for smoothly moving air.

The step of preparing the second gel polymer electrolyte membrane 232 may further include a step of bonding a current collector 250 to the other surface (second surface) of the anode 240. The current collector 250 may serve to transport electrons generated by the oxygen reduction reaction.

### EXAMPLE

Hereinafter, the present invention will be described in more detail with reference to the following embodiments. However, the present invention is not limited thereto.

### Embodiment 1

(1) Preparation of First Gel Polymer Electrolyte Slurry

In order to prepare the first gel polymer electrolyte slurry, which contacts the cathode 220, polymethyl methacrylate was used as the polymer. A solution in which 1M LiNO₃ was mixed with a DMAc solvent was used as the first electrolyte, and 2,2′-azo-bisisobutyronitrile (AIBN) was used as the initiator. Divinylbenzene (DVB) was used as the crosslinking agent. The first gel polymer electrolyte slurry was prepared by mixing 21% by weight of the polymer, 75% by weight of the first electrolyte, 1% by weight of the initiator, and 3% by weight of the cros slinking agent.

(2) Preparation of Second Gel Polymer Electrolyte Slurry

In order to prepare the second gel polymer electrolyte slurry, which contacts the anode 240, polyvinylidene fluoride was used as the polymer. A solution in which 1M LiTFSI was mixed with a DEGDEE solvent was used as the second electrolyte, and 2,2′-azo-bisisobutyronitrile (AIBN) was used as the initiator. Poly(propylene glycol)diacrylate was used as the crosslinking agent. The second gel polymer electrolyte slurry was prepared by mixing 28% by weight of the polymer, 70% by weight of the liquid electrolyte, 1% by weight of the initiator, and 1% by weight of the crosslinking agent.

(3) Manufacture of Lithium-Air Battery 200

The gas diffusion layer 210, the cathode 220, the anode 240 and the current collector 250, which constitute the lithium-air battery 200, were bonded to each other using a method known in the art. However, the separation membrane 233, which formed the gel polymer electrolyte membrane, was bonded in the following way to manufacture the lithium-air battery 200. The first gel polymer electrolyte slurry was cast on the cathode 220, made of porous carbon, using a doctor blade. After the lithium anode 240 was bonded onto the nickel current collector 250, the second gel polymer electrolyte slurry was cast on the lithium anode 240 in the same manner as described above. Subsequently, the cathode 220, on which the first gel polymer electrolyte slurry was cast, and the anode 240, on which the second gel polymer electrolyte slurry was cast, were gelled through thermal polymerization at a temperature of 70° C. for 6 hours. Subsequently, 30 μl of first electrolyte was additionally injected into the polymer matrix, which was formed into the first gel polymer electrolyte membrane 231, and 30 μl of second electrolyte was additionally injected into the polymer matrix, which was formed into the second gel polymer electrolyte membrane 232. Subsequently, the lithium-ion conductive separation membrane 233, which was made of a PEO₁₅LiTFSI polymer electrolyte, was bonded between the first gel polymer electrolyte membrane 231 and the second gel polymer electrolyte membrane 232. Subsequently, the gas diffusion layer 210, which was a nickel foam, was bonded to the other surface of the cathode 220 in order to manufacture the lithium-air battery 200. The first gel polymer electrolyte membrane 231 formed through this process had a thickness of 70 μm, and the mixing ratio of the polymer matrix to the first electrolyte was 20:80 by weight. The second gel polymer electrolyte membrane 232 formed through this process had a thickness of 50 μm, and the mixing ratio of the polymer matrix to the second electrolyte was 35:65 by weight.

### Embodiment 2

A lithium-air battery was manufactured in the same manner as in Embodiment 1, except that the following components were used. In the preparation of a first gel polymer electrolyte slurry, polymethylmethacrylate-co-polystyrene (PMMA-PS) was used as a polymer. Polyethylene was used as a separation membrane.

### Comparative Example 1

A gas diffusion layer, a cathode, an anode and a current collector were prepared using the same materials as those in Embodiment 1. Polyethylene was used as a separation membrane, and an electrolyte in which 1M LiTFSI was mixed with DEGDEE was used as an electrolyte to be impregnated in the separation membrane.

Subsequently, without forming a gel polymer electrolyte membrane, the above materials were bonded to form a gas diffusion layer/cathode/separation membrane/anode/current collector structure using a method known in the art, thereby manufacturing a lithium-air battery. Subsequently, a separator, made of graphite, was bonded onto each of the gas diffusion layer and the current collector of the lithium-air battery.

### Comparative Example 2

A lithium-air battery was manufactured in the same manner as in Comparative Example 1, except that an electrolyte in which 1M LiNO₃ was mixed with a DMAc solvent was used as an electrolyte to be impregnated in the separation membrane.

Comparative Example 3

A lithium-air battery was manufactured in the same manner as in Comparative Example 1, except that an electrolyte in which 1M LiTFSI was mixed with a mixed solvent, in which PMMA and DMAc were mixed at a weight ratio of 1:1, was used as an electrolyte to be impregnated in the separation membrane.

### Experimental Example

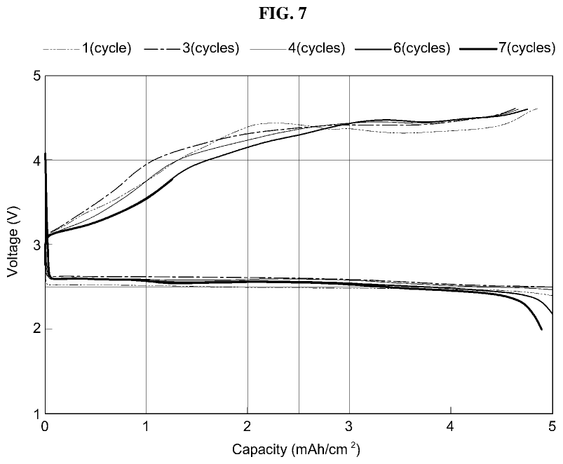

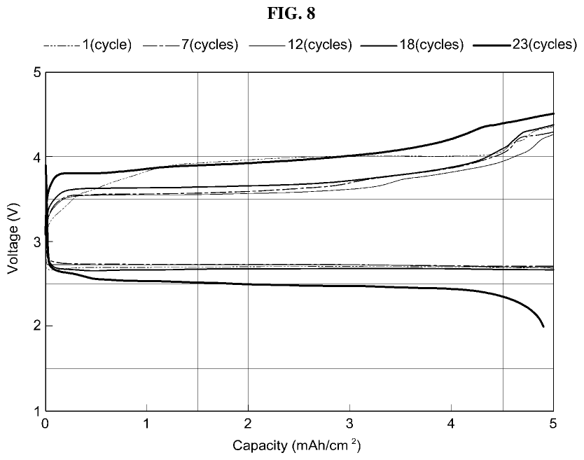

In order to confirm the initial battery capacity and the charge/discharge lifespan characteristics of each of the lithium-air batteries of Embodiments 1 and 2 and Comparative Examples 1 to 3, charging and discharging were performed at a voltage of 2 V, a capacity of 5 mAh/cm² and a current density of 0.5 mA/cm². The results are shown in Table 1 below and in FIGS. 7 and 8.

TABLE 1

| | Energy | Initial | Lifespan |
|---|---|---|---|
| | Density | Battery Capacity | Evaluation |
| Classification | (Wh/kg) | (mAh/cm²) | (Cycles) |
| Embodiment 1 | 224 | 12 | 23 |
| Embodiment 2 | 186 | 15 | 20 |
| Comparative | 51 | 6 | 7 |
| Example 1 | | | |
| Comparative | 128 | 10 | 17 |
| Example 2 | | | |
| Comparative | 185 | 10 | 10 |
| Example 3 | | | |

According to the results of Table 1 and FIGS. 7 and 8, in the case of Comparative Example 1 using the conventional separation membrane, the initial battery capacity thereof was extremely low, i.e. about half that of Embodiment 1, and a discharge product, which was formed by the influence of the electrolyte, was accumulated on the surface of the electrode, with the result that an extremely high overvoltage occurred when decomposing the discharge product during a charge operation. Further, the evaluated charge/discharge lifespan was very low, i.e. about 7 cycles. In the case of Comparative Examples 2 and 3, the initial battery capacity and the energy density were high due to the relatively high impregnation properties of the liquid electrolyte. However, an electrochemical reaction product was irreversibly accumulated on the surface of the electrode, and it was impossible to avoid volatilization of the liquid electrolyte, with the result that the evaluated lifespan was not high.

On the other hand, in Embodiments 1 and 2, the initial battery capacities thereof were extremely high, i.e. 12 mAh/cm² and 10 mAh/cm², respectively. In addition, overvoltage was greatly reduced and the lifespan was prolonged compared to Comparative Example 1. Particularly, since no separator was included, energy density was increased about four times or more.

According to various exemplary embodiments described above, the present invention provides a lithium-air battery, which may have reduced weight thereof and improved the energy density thereof by eliminating two separators, which are provided on a gas diffusion layer and a current collector in the related art.

In addition, according to a lithium-air battery according to the present invention, instead of eliminating separators, gel polymer electrolyte membranes, which may be formed by gelling liquid electrolytes, may serve as a separation membrane, thereby restricting the fluidity of the electrolytes and consequently preventing volatilization, leakage or bias of the electrolytes.

In addition, a lithium-air battery according to various exemplary embodiments of the present invention may include two kinds of gel polymer electrolyte membranes, each including an electrolyte suitable for a corresponding one of a cathode and an anode, as a separation membrane, thereby improving electrode stability and increasing a battery capacity and lifespan.

It will be appreciated by those skilled in the art that the effects achievable through the invention are not limited to those that have been particularly described hereinabove, and other effects of the invention will be more clearly understood from the above detailed description.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A lithium-air battery comprising:
a cathode;
a gel polymer electrolyte membrane comprising a first gel polymer electrolyte membrane and a second gel polymer electrolyte membrane; and
an anode,
wherein the first gel polymer electrolyte membrane contacts with the cathode and the second gel polymer electrolyte membrane contacts with the anode, and
wherein the first gel polymer electrolyte membrane comprises a first polymer matrix and a first electrolyte impregnated in the first polymer matrix, and the second gel polymer electrolyte membrane comprises a second polymer matrix and a second electrolyte impregnated in the first polymer matrix,
wherein the first polymer matrix and the second polymer matrix are same or different.

2. The lithium-air battery of claim 1, wherein the first polymer matrix and/or the second polymer matrix have a semi-interpenetrating polymer network structure in which polymer chains are crosslinked with each other.

3. The lithium-air battery of claim 2, wherein the first polymer matrix and the second polymer matrix comprise one or more polymers selected from the group consisting of polymethylmethacrylate, polyacrylonitrile, polyethylene oxide, polymethylmethacrylate-co-polystyrene, polyvinylidene fluoride, and polytetrafluoroethylene.

4. The lithium-air battery of claim 1, wherein the first electrolyte comprises one or more organic solvents selected from the group consisting of an amide-based compound, a nitrile-based compound and a sulfur-based compound.

5. The lithium-air battery of claim 1, wherein a mixing ratio of the first polymer matrix to the first electrolyte ranges from about 10:90 to about 40:60 by weight.

6. The lithium-air battery of claim 1, wherein the second electrolyte comprises one or more organic solvents selected from the group consisting of an ether-based compound, a carbonate-based compound, and an ionic liquid.

7. The lithium-air battery of claim 1, wherein a mixing ratio of the second polymer matrix to the second electrolyte ranges from about 30:70 to about 40:60 by weight.

8. The lithium-air battery of claim 1, wherein the first gel polymer electrolyte membrane has a thickness greater than a thickness of the second gel polymer electrolyte membrane.

9. The lithium-air battery of claim 1, further comprising:
a separation membrane disposed between the first gel polymer electrolyte membrane and the second gel polymer electrolyte membrane.

10. The lithium-air battery of claim 9, wherein the separation membrane comprises a lithium-ion conductive separation membrane or a polymer separation membrane.

11. A method of manufacturing a lithium-air battery, the method comprising:
preparing a first gel polymer electrolyte membrane by coating a first gel polymer electrolyte slurry on a first surface of a cathode;
preparing a second gel polymer electrolyte membrane by coating a second gel polymer electrolyte slurry on a first surface of an anode; and
bonding the first gel polymer electrolyte membrane onto the second gel polymer electrolyte membrane such that the first surface of the cathode and the first surface of the anode face each other,
wherein the first gel polymer electrolyte membrane comprises a first polymer matrix and a first electrolyte impregnated in the polymer matrix, and the second gel polymer electrolyte membrane comprises a second polymer matrix and a second electrolyte impregnated in the polymer matrix.

12. The method of claim 11, wherein the first gel polymer electrolyte slurry comprises an amount of about 13 to 28% by weight of a first polymer, an amount of about 62 to 84% by weight of the first electrolyte, an amount of about 1 to 3% by weight of a first initiator, and an amount of about 2 to 7% by weight of a first crosslinking agent, all the % by weight based on the total weight of the first gel polymer electrolyte slurry.

13. The method of claim 11, wherein the preparing the first gel polymer electrolyte membrane comprises polymerizing the first gel polymer electrolyte slurry coated on the one surface of the cathode at a temperature of about 60 to 80° C. for about 6 to 12 hours to form the first gel polymer electrolyte membrane.

14. The method of claim 11, further comprising:
additionally impregnating the first electrolyte into the first polymer matrix of the first gel polymer electrolyte membrane after the preparing the first gel polymer electrolyte membrane.

15. The method of claim 11, wherein the second gel polymer electrolyte slurry comprises an amount of about 22 to 38% by weight of a second polymer, an amount of about 54 to 76% by weight of the second electrolyte, an amount of about 1 to 3% by weight of a second initiator, and an amount of about 1 to 5% by weight of a second crosslinking agent, all the % by weight based on the total weight of the second gel polymer electrolyte slurry.

16. The method of claim 11, wherein the preparing the second gel polymer electrolyte membrane comprises polymerizing the second gel polymer electrolyte slurry coated on the one surface of the anode at a temperature of about 60 to 80° C. for about 6 to 12 hours to form the second gel polymer electrolyte membrane.

17. The method of claim 11, further comprising:
additionally impregnating the second electrolyte into the second polymer matrix of the second gel polymer electrolyte membrane after the preparing the second gel polymer electrolyte membrane.

18. The method of claim 11, further comprising:
bonding a separation membrane onto the second gel polymer electrolyte membrane after the preparing the second gel polymer electrolyte membrane and before the bonding the first gel polymer electrolyte membrane onto the second gel polymer electrolyte membrane.

19. A vehicle comprising a lithium-air battery of claim 1.
